(19) United States
(12) Patent Application Publication
(10) Pub. No.: US 2017/0025025 A1
(43) Pub. Date: Jan. 26, 2017

(54) TOOL AND METHOD TO AID IN FOCUSING

(71) Applicants: Barry J. Pechner, Cary, NC (US); Scott F. Pechner, Cary, NC (US)

(72) Inventors: Barry J. Pechner, Cary, NC (US); Scott F. Pechner, Cary, NC (US)

(21) Appl. No.: 14/808,066

(22) Filed: Jul. 24, 2015

(51) Int. Cl. G09B 1/02; A45F 5/00

(52) U.S. Cl. CPC G09B 1/02; A45F 5/00

(57) ABSTRACT

The present invention is a bracelet for aiding in reminding the user to do a particular item, task, detail, or event. The bracelet consists of tiles which have a first image on the front side and a second image on the obverse side and can be flipped from one side to the other to indicate something is to be remembered or accomplished.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

Field of the Invention

The present invention relates to a focus tool, kit, and method. In particular, it relates to a bracelet for assisting a user in focusing, e.g. remembering (a reminder), tracking, celebrating, etc. a particular event or thing.

Description of Related Art

The use of various techniques to aid in focus (remember, track, or the like) for something like a task, drinking water, quitting smoking, and the like event, thing, or the like is widespread, essentially universal. One common way to remember is a mnemonic device, for when several items are needed to be remembered, like a list of names. Tasks, events, or the like are frequently accompanied by a list of things to do, like a shopping list or the like. Events put on calendars help, but are difficult to use. These things require the user remembering they have something to do in the first place. Electronic devices have provided some solutions, but one must spend money and remember to have the electronics working, charged, and with them at all times.

The old fashioned way of remembering to do something was to tie a string on the finger or draw a symbol on the skin. The out of place object or drawing reminds the individual to remember. While these do aid in the memory of tasks, one has to wear something a bit embarrassing, not to mention also having to carry string around. Drawing on the skin has the drawback of getting clothing and other items dirty, as well as the embarrassment of having something written on the palm of the user's hand, and them looking a bit foolish. A list requires pen and paper, or a computer, which can easily be forgotten.

There is still a need for a focus tool that is easy to use, inexpensive, and easy to have on you without looking foolish or out of place. There is a need for a focus tool that is easy to have with you at all times, and to date no such device or method exists.

### BRIEF SUMMARY OF THE INVENTION

The present invention relates to a focus and goal tracking tool having a wristband with one or more two-sided tiles mounted on the band in such a way that a user can flip each tile from a first side to a second different side. As long as there is something different on each side, e.g. a symbol on one side and a different symbol or nothing on the other, the tile can easily be seen to be flipped and the flipped tile becomes a device which acts to remind the individual what the task to be done is or track an accomplished task or celebrate an event (e.g. team name on one side, logo on the other) or other focus tool, or the like. Where there are multiple tiles, a flipped tile becomes even more obviously out of place. One can use the bracelet by placing icons/images of interests, like sports, schools, decorative designs, advertising symbols, hydration, prayer, attitude, habits, tasks, fundraising, and the like, or other printouts of interest on each tile on both sides.

Accordingly, in one embodiment, there is a method of focus or goal tracking for an individual comprising:
a) selecting a focus and goal tracking tool comprising a bracelet having one or more tiles attached to the bracelet, each tile having a front face and an obverse face, wherein each tile has a first image on the front face and a second image on the back face, wherein the bracelet allows each tile to be flipped from one face to the other, and back; and
b) turning at least one of the tiles to its opposite face when there is a focus or goal to be tracked.

And, in another embodiment, there is a focus and goal tracking tool comprising:
a) a bracelet; and
b) one or more tiles attached to the bracelet each tile having a front face and an obverse face, having a first image on the front face and a second image on the back face wherein the bracelet allows each tile to be flipped from one face to the other and back.

A kit of parts to assemble the device comprising:
a. a bracelet having one or more tiles attached to the bracelet, each time having a front face and a back face;
b. stickers of images to position on the front face and back faces; and
c. a container for a) and b).

### BRIEF DESCRIPTION OF THE DRAWINGS

FIG. 1 is a perspective of the bracelet of the invention with front face tiles.

FIG. 2 is a perspective of the bracelet with obverse faces showing.

FIG. 3 is a perspective of the bracelet on a user's wrist with one tile turned over to indicate focus and tracking.

FIG. 4 is a perspective of a portion of the bracelet having a water drop on the front face and a reward (smiling face) on the obverse face.

FIG. 5 is a view of a kit of parts.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitations thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the phrase “focus and goal tracking” refers to the situation wherein there is an individual with something they do not want to do at the moment or want to do at the moment, but want to remember that activity, or such things as remembering to do something, keeping track of, or recording, one or more things, positive reinforcements, creating good habits or attitudes, breaking bad habits, as well as advertising, prayer, tasks and the like. The device also has a unique conversation piece quality. While there are many ways, e.g. electronic, to accomplish this, in this particular invention it relates to an easy non-electronic method at hand. The task can be anything wherein an individual decides which particular task to do, like making a phone call, taking medicine, writing a letter or the like. The task itself is not important, it is remembering that there is a task to do that is important. Tracking can be such things as tracking amount of water drank, times a cigarette is refused, times you made someone smile, bad habits not done, or the like. It can be utilized with school messages or anything that meets the criteria of the bracelet. The reverse side can act as a reinforcement tool by giving a reward e.g. a smiling face or other positive image.

As used herein, the term “bracelet” refers to a band, hoop, or chain worn on the wrist. In one embodiment, the band is an elastic band, though any relatively small, thin type bracelet that allows tiles mounted on the bracelet to be turned from a front side to a back side will be encompassed by the present invention.

As used herein, the term “one or more tiles” refers to a flat or curved piece of fired clay, stone, wood, plastic, metal, concrete or the like, similar to pieces like those used in Scrabble®, or other game-type pieces having a front face and an obverse face. They can be round or rectangular, or any other shape, and they can be flat or have a curve, especially curved to fit the curve on the wrist. The surface of each face can be smooth or textured or the like. Each tile may have the same decoration/image or the like on all the front faces of the tiles of the bracelet, and a different set of images on each of the obverse faces, i.e. total of two (or more) images per bracelet. The term “image” refers to what is on each face of a tile. The image can be nothing but the color or surface of the tile, or it can be a drawing, picture, letters, numbers, icon, advertisements, logos, schools, decorative designs, organization images or the like. The number of tiles depends on the wrist size and the tiles size. Other examples might be team logos, school logos, city names, people's names or the like. There can be a single tile or multiple tiles. The tiles are attached to the bracelet in a manner where each tile can be viewed on the front face or flipped over and viewed on the obverse face as shown in the Figures. The image can be printed on the tiles, or, in one embodiment, stickers (e.g. vinyl or the like) can be applied to create the images e.g. stickers on one side, with a water drop on the front face (to remind you to drink water) and a smiley face on the other or the like. In this embodiment, the tile is turned over after a glass of water is drank and the user is rewarded with a smiley face, which also tracks the number of glasses of water drank. In one embodiment, the invention is a kit of parts comprising stickers, bracelets with tiles and a container.

In one embodiment, there is a task to be remembered, the user, wishing to remember a task, has but to observe on of the preprogramed tiles and flip it over to record the action taken. Therefore, when there is a task to be remembered, the user wishing to remember a task would take one of the tiles and flip it over to the obverse (other) side. This is done as a reminder that there is a task to remember or recording it is done and in some cases a reward, a smiley face, that the task is accomplished. So, for example, where there is an A on the front face and a 1 on the obverse face, the user can flip/rotate the tile to the obverse side having the 1. The bracelet can have multiple tiles, and one can turn over one or more tiles to remember, for example, turning over many tiles when it is very important and one tile when it is not as important. There can be multiple tiles such as 1, 2, 3, 4, 5, 6, 7, 8, 9, 10 or more tiles on each bracelet, depending on the size of the tile and sizes of the user's wrist. The tiles can go all the way around the wrist or can go partway around the wrist, for example only on the upper side of the wrist where it can easily be seen, or it can be only on the inside of the wrist where a watch might be seen. For tracking, recording, or the other features, the same is done i.e. flip over tile to remember to do something, or after doing something to track it, or the like.

In the process of remembering, the individual user would glance at the bracelet and when the user notices a specific icon to be remembered, that tile is turned to the obverse face, which records the action. The use of having the device on the wrist therefore means that the device is available everywhere the user goes, and the user will not forget to look at it. In the process of tracking, the user will turn over a tile upon accomplishing a task.

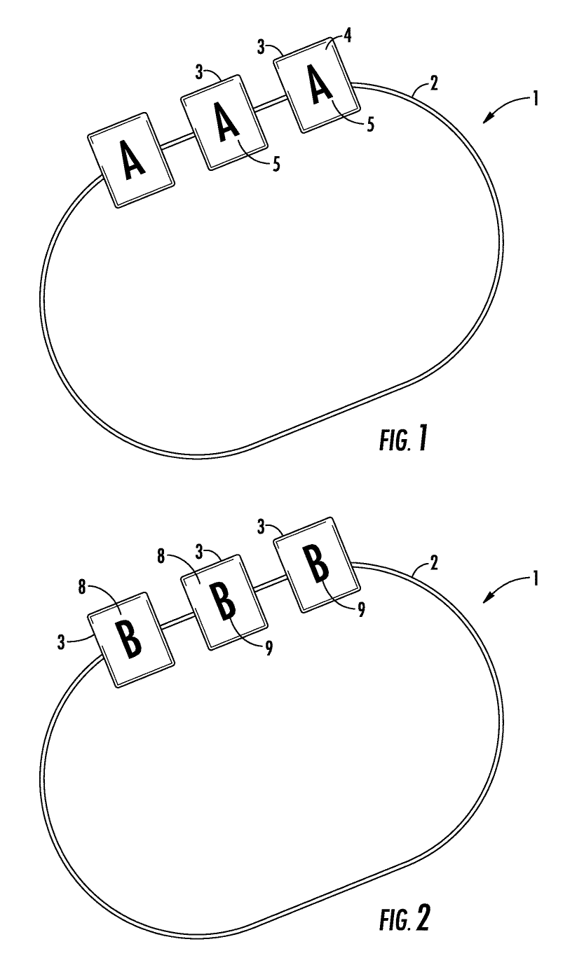

Now, referring to the drawings; FIG. 1 is a perspective view of the present invention. In this view, a focus and goal tracking tool 1 comprises a bracelet 2 which is shown as an elastic band, but could be any basic band or hoop as described above. Next are the tiles 3, and in this view, there are three tiles but there could be one or more as desired. The front face 4 is shown of tiles 3 and in this view there is the letter A 5 on each face of each tile 3. In one embodiment, there are about seven to fifteen tiles on the bracelet.

FIG. 2 is a perspective of the focus and goal tracking tool 1 wherein the tiles 3 have the obverse face 8 shown with the letter B 9 on the obverse face 8.

FIG. 3 is the focus and goal tracking tool 1 on the wrist 10 of a user. In this view, tile 3 has been flipped to the obverse face 8, while the remaining two tiles are still on their front face 4. The user would look at the three tiles 3 and see that one is flipped over (by the user) at some earlier time, and know that there is a task to remember or turns a tile over to mark an event having occurred.

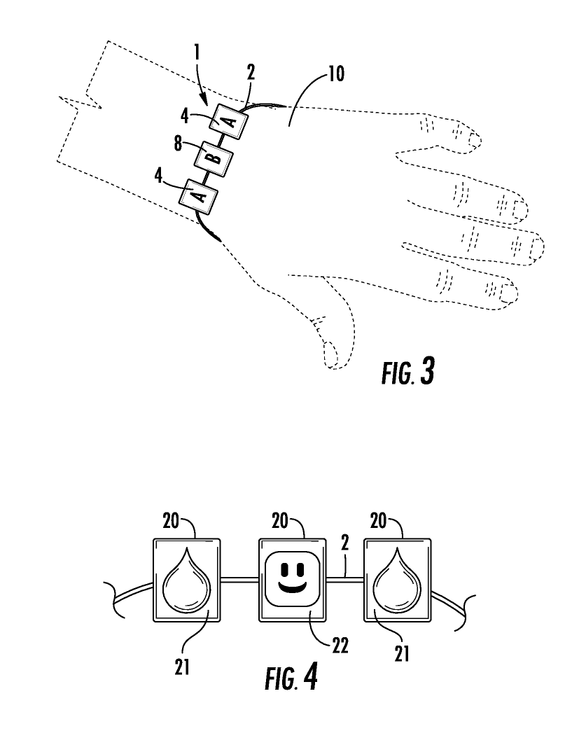

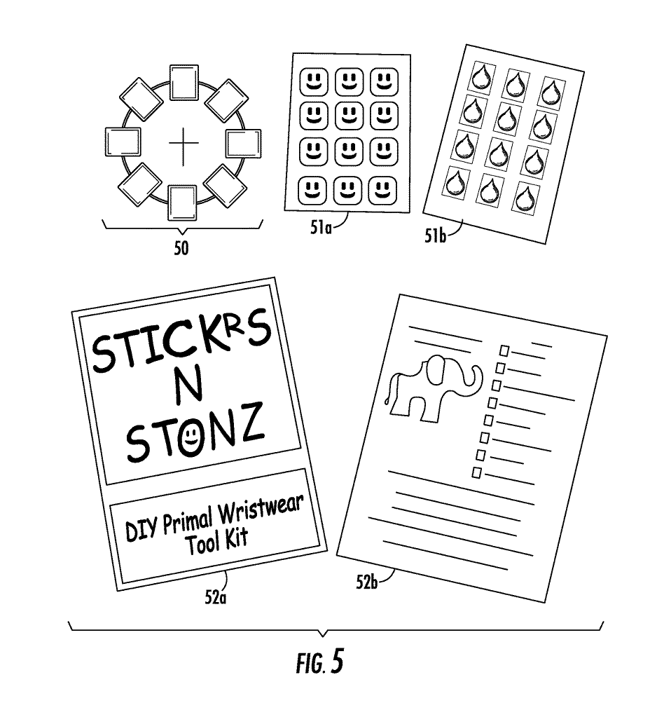

FIG. 4 is a partial perspective of a bracelet 8 having tiles 20 with a water drop on a front side 21 and a smiley face 22 on the obverse. The smiley face 22 can be considered a psychological reward type image, i.e. something pleasant to see as a reward for turning over a tile.

FIG. 5 is a kit of parts with bracelet 50, stickers 51a and 51b, and a container with a front 52a and back 52b.

### EXAMPLES

### Example 1

### Hydration

The hydration bracelet on page 9, with a water droplet on the front side and a smiley face on the second side, as an example, is placed on the wrist each morning and the tiles are all set with the water droplet facing outward. In the course of the day, as the wearer observes the water droplet icons on their wrist, it reminds them of their commitment to hydrate. When they do hydrate, they flip over a tile to record that action. By day's end, a tally of the happy faces seen on the bracelet tells if their quantitative daily goal has been met. The happy faces are the accumulated rewards for the actions that were taken and provide positive reinforcement.

### Example 2

### Smoking Cessation

A non-smoking bracelet with a non-smoking icon on the front and a smiley face on the back. All non-smoking icons are face up at the start of the day. When the icons are noticed during an automatic response action (attempting to get the cigarette), there is a moment of pause, wherein the person asks him/herself “Do I really want or need this now?” If they find that they don't really want or need the cigarette at that time, they simply flip a tile over and get an immediate positive reinforcement. Automatic responses are the triggers that cause this habit which mimic a robot's programming.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A method of focus or goal tracking for an individual comprising:
a) selecting a focus and goal tracking tool comprising a bracelet having one or more tiles attached to the bracelet, each tile having a front face and an obverse face, wherein each tile has a first image on the front face and a second image on the back face, wherein the bracelet allows each tile to be flipped from one face to the other, and back; and
b) turning at least one of the tiles to its opposite face when there is a focus or goal to be tracked.

2. The method according to claim 1 wherein there are a plurality of tiles.

3. The method according to claim 1 wherein the bracelet is elastic.

4. The method according to claim 1 wherein each tile has an image of nothing on one face of the tile.

5. The method according to claim 1 wherein one face of each tile has a psychological reward type image.

6. The method according to claim 1 wherein the image is selected from the group consisting of a sports image, a school image, a decorative image, an advertising image, an organization image, a habit, an attitude, task image and fundraising images.

7. The method according to claim 1 wherein each image on the face of each tile is an image of something to track.

8. The method according to claim 7 wherein drinking water is tracked.

9. The method according to claim 7 wherein cigarettes avoided is tracked.

10. The method according to claim 1 wherein the tiles do not go all the way around the wrist and just are visible during use on an upper side of the wrist

11. A focus and goal tracking tool comprising:
a) a bracelet; and
b) one or more tiles attached to the bracelet, each tile having a front face and an obverse face, having a first image on the front face and a second image on the back face, wherein the bracelet allows each tile to be flipped from one face to the other and back.

12. The device according to claim 11 wherein the tiles can be flipped by use of a bracelet that connects the tiles by a single or double cord that runs through each tile.

13. The device according to claim 12 wherein the cord is elastic.

14. The device according to claim 11 wherein there are a plurality of tiles.

15. The device according to claim 11 wherein each tile has an image of nothing on one face of the tile.

16. The device according to claim 11 wherein one face of each tile has a psychological reward type image.

17. The device according to claim 11 wherein the image is selected from the group consisting of a sports image, a school image, a decorative image, an advertising image, and an organization image.

18. The device according to claim 11 wherein each image on the face of each tile is an image of something to track.

19. The device according to claim 18 wherein the image on one side is selected from the group consisting of hydrations images, prayer images, or habit breaking images.

20. The device according to claim 19 wherein the habit breaking image is a smoking cessation image.

21. A kit of parts to assemble the device according to claim 11 comprising:
a) a bracelet having one or more tiles attached to the a bracelet, each tile having a front face and a back face;
b) stickers of images to position on the front face and back faces; and
c) a container for a) and b).
